(19) United States
(12) Patent Application Publication
(10) Pub. No.: US 2026/0080567 A1
(43) Pub. Date: Mar. 19, 2026

(54) METHOD FOR CALIBRATING A TRAFFIC ENFORCEMENT DEVICE

(71) Applicant: IDEMIA ROAD SAFETY FRANCE, Courbevoie (FR)

(72) Inventors: Grégoire CARRION, Courbevoie (FR); Eric GUIDON, Courbevoie (FR); Samuel ALLIOT, Courbevoie (FR); Rachid HARBI, Courbevoie (FR); Thomas SUBECZ, Courbevoie (FR)

(73) Assignee: IDEMIA ROAD SAFETY FRANCE, Courbevoie (FR)

(21) Appl. No.: 19/331,032

(22) Filed: Sep. 17, 2025

(30) Foreign Application Priority Data
Sep. 19, 2024 (FR) FR2409999

(51) Int. Cl. G06T 7/80; G01S 13/86; G01S 13/91; G06T 7/246; G08G 1/04

(52) U.S. Cl. CPC G06T 7/80; G01S 13/867; G01S 13/91; G06T 7/248; G08G 1/04; G06T 2207/30236

(57) ABSTRACT

A method for calibrating a traffic enforcement device comprising a camera and a radar, the method comprising: estimating position and orientation parameters of the camera and the radar in a reference frame associated with a lane of a road; acquiring, data relating to the path of a given vehicle in the lane of the road; determining, a camera path of the vehicle based on the data acquired by the camera and of the estimated position and orientation parameters, and determining, a radar path of the vehicle based on the data acquired by the radar and of the estimated position and orientation parameters; and computing, based on the camera path and of the radar path, corrected values for the estimated position and orientation parameters of the camera, including a parameter quantifying the angle of elevation, and a parameter quantifying the height, of the camera.

### TECHNICAL FIELD

The present disclosure relates to a method for calibrating a traffic enforcement device comprising a camera and a radar, and to a traffic enforcement device configured to implement this method. The present disclosure is in particular applicable to the calibration of mobile traffic enforcement devices, in particular mobile traffic enforcement devices that are able to be placed in different geographical locations at different times, depending on how these devices are required to be used.

### PRIOR ART

Recent traffic enforcement devices comprise, in addition to a radar, a camera the resolution and field width of which make it possible to track the path of vehicles in the stream of images. For a vehicle to be considered to have committed an offence, it is generally necessary for it to be detected both by the radar and by the camera, and for the vehicle paths acquired by the radar and camera to be consistent.

In order to be usable, the data acquired by the camera, in particular the successive positions of the vehicle in the images obtained by the camera, must be converted into data on the position of the vehicle in a reference frame associated with the road. However, the conditions of use of traffic enforcement devices are such that the camera is located close to the ground with a grazing orientation, i.e. located at a low height with a small angle of elevation. Under these conditions, it is necessary to determine the values of parameters quantifying elevation and height very accurately, because any uncertainty in these values may have a substantial effect on the determined position of the vehicle in the reference frame associated with the road. For example, an uncertainty of a few tenths of a degree in the angle of elevation may result in an error in the position of the vehicle of several meters.

This problem is especially acute for mobile traffic enforcement devices. Specifically, for a device intended to be operated at a fixed location, it is possible to accurately determine the topography of the site and therefore to accurately determine the position parameters of the camera.

FR 3096786 A1 [IDEMIA IDENTITY & SECURITY FRANCE [FR]] 04.12.2020 describes a method for determining the position and orientation of a camera of a traffic enforcement device with respect to a road, that requires a total station to be used. However, this is incompatible with the operational constraints of mobile traffic enforcement devices, which may be moved, for example every day or several times a day, to different locations.

FR 3131777 A1 [IDEMIA IDENTITY & SECURITY FRANCE [FR]] 14.07.2023 describes a method for aligning a camera in the vicinity of a road, in particular for mobile traffic enforcement devices, allowing the position and orientation parameters of the camera with respect to the road to be estimated.

### SUMMARY

One aim of the present disclosure is to provide a method for calibrating a traffic enforcement device allowing a more accurate estimation of parameters quantifying the height and elevation of the camera of such a device, i.e. an estimation accurate to one tenth of a meter and to one tenth of a degree, respectively.

According to a first aspect of the invention, a method is provided for calibrating a traffic enforcement device comprising a camera and a radar, the method comprising the following steps:
estimating position and orientation parameters of the camera and radar in a reference frame (O, x, y, z) associated with a lane of a road;
acquiring, by means of the camera and radar, data relating to the path of at least one given vehicle in the lane of the road;
determining, on the one hand, a camera path of the vehicle in the reference frame (O, x, y, z) associated with the lane of the road on the basis of the data acquired by the camera and of the estimated position and orientation parameters, and on the other hand, a radar path of the vehicle in the reference frame (O, x, y, z) associated with the lane of the road on the basis of the data acquired by the radar and of the estimated position and orientation parameters;
computing, on the basis of the camera path and of the radar path, corrected values for at least some of the estimated position and orientation parameters of the camera, including a parameter quantifying the angle of elevation, e, and a parameter quantifying the height, h, of said camera.

According to some embodiments, the radar path and the camera path each comprise data on the position of the vehicle in the reference frame (O, x, y, z) associated with the lane of the road, said data being acquired at respective acquisition times, and the step of computing corrected values for the parameters comprises a substep of correcting the data on the position of the vehicle of the radar path and of the camera path for identical acquisition times.

According to some embodiments, the radar and the camera have different data acquisition rates, and the correcting substep comprises an interpolation of one of the radar path and/or camera path so that both paths comprise position data corresponding to identical acquisition times.

According to some embodiments, the computing step comprises computing corrected values for angle of elevation, e, and for height, h, and said method comprises a step of updating the value of at least one of a road-edge distance, d, and of an angle of roll, r, of the camera on the basis of said corrected values.

According to some embodiments, the camera path and the radar path each comprise a time series of positions of the vehicle along an axis [Ox) of the reference frame (O, x, y, z) associated with the lane of the road, the axis [Ox) being tangential to an edge of the lane of the road, and the step of computing corrected values comprises computing corrected values for the angle of elevation, e, and for the height, h, of the camera, and a substep of minimizing differences in position between the time series of the camera path and radar path.

According to some embodiments, the camera path and the radar path each comprise a time series of distances of the vehicle from the traffic enforcement device, and the step of computing corrected values for the position and orientation parameters of the camera comprises a substep of minimizing this distance in all of said time series.

According to some embodiments, the step of computing corrected values comprises the following substeps:
computing a quantity D1(t)*H2/D2(t) as a function of D1(t), where D1(t) is the time sequence of distances of the vehicle from the traffic enforcement device provided by the radar, D2(t) is the time sequence of distances of the vehicle from the traffic enforcement device provided by the camera, and H2 is the estimated height of the camera;
modeling the quantity D1(t)*H2/D2(t) as a function of D1(t) with an affine function;
computing a correction of the angle of elevation, e, using the value of the slope of the affine function, and the corrected value for the height, h, of the camera on the basis of the y-coordinate at the origin of the affine function.

According to a second aspect of the invention, a computer program is provided, this computer program comprising instructions that, when they are executed by a data-processing unit, cause said device to implement code for implementing a method comprising the following steps:
estimating position and orientation parameters of the camera and radar in a reference frame (O, x, y, z) associated with a lane of a road;
controlling the camera and radar so as to acquire, by means of the camera and radar, data relating to the path of at least one given vehicle in the lane of the road;
determining, on the one hand, a camera path of the vehicle in the reference frame (O, x, y, z) associated with the lane of the road on the basis of the data acquired by the camera and of the estimated position and orientation parameters, and on the other hand, a radar path of the vehicle in the reference frame (O, x, y, z) associated with the lane of the road on the basis of the data acquired by the radar and of the estimated position and orientation parameters;
computing, on the basis of the camera path and of the radar path, corrected values for at least some of the estimated position and orientation parameters of the camera, including a parameter quantifying the angle of elevation, e, and a parameter quantifying the height, h, of said camera.

According to a third aspect of the invention, a traffic enforcement device is provided, this traffic enforcement device comprising a camera, a radar, and a processing unit, the traffic enforcement device being configured to implement the calibrating method according to any of the embodiments described above.

The method according to the invention makes it possible to accurately determine the height and angle of elevation of the camera on the basis of paths of one or more vehicles, acquired by the radar and the camera. The data on the position of a vehicle acquired by a radar such as, for example, a Doppler radar or LIDAR are hardly sensitive, or not sensitive at all, to the height and angle of elevation of the radar, unlike a camera. Based on the radar data, it is thus possible to correct the position and orientation parameters of the camera so that the data on the position of the vehicle acquired by the camera match the data on the position of the vehicle acquired by the radar. Accuracy of one tenth of a degree in the angle of elevation of the camera may thus be achieved, and of one hundredth of a meter in the height.

### BRIEF DESCRIPTION OF THE DRAWINGS

FIG. 1 is a schematic representation of a road the traffic of which is controlled by means of a traffic-enforcement device.

FIG. 2 is a schematic representation of a traffic enforcement device according to one embodiment.

FIG. 3 is a schematic representation of the camera in the (x, y) plane of an orthonormal reference frame (O, x, y, z) associated with the road.

FIG. 4 is a schematic representation of a camera in the (x, z) plane of an orthonormal reference frame (O, x, y, z) associated with the road.

FIG. 5 is a flowchart of a method for calibrating a traffic enforcement device according to a first embodiment.

FIG. 6 is a flowchart of a method for calibrating a traffic enforcement device according to a second embodiment.

FIG. 7 is one example of a graph of the path, as a function of time, of a given vehicle according to the camera and according to the radar of the traffic enforcement device, each path being formed by a time series of positions of the vehicle along an axis tangential to an edge of the road.

FIG. 8 is a graph of the paths of FIG. 6 after correction of the position and orientation parameters of the camera using a method according to the invention.

FIG. 9 is a schematic representation of the distance of a vehicle from the traffic enforcement device.

FIG. 10 is a graph of the distances, as a function of time, of a given vehicle from the traffic enforcement device, as determined by the radar (empty circles) or the camera (crosses).

FIG. 11 is a graph of the ratio D1*H2/D2 as a function of D1 and of modeling thereof by an affine function, where D1 and D2 are the time sequences of distances of FIG. 9, and H2 is the estimated height of the camera of the traffic enforcement device, respectively.

### DETAILED DESCRIPTION OF AT LEAST ONE EMBODIMENT

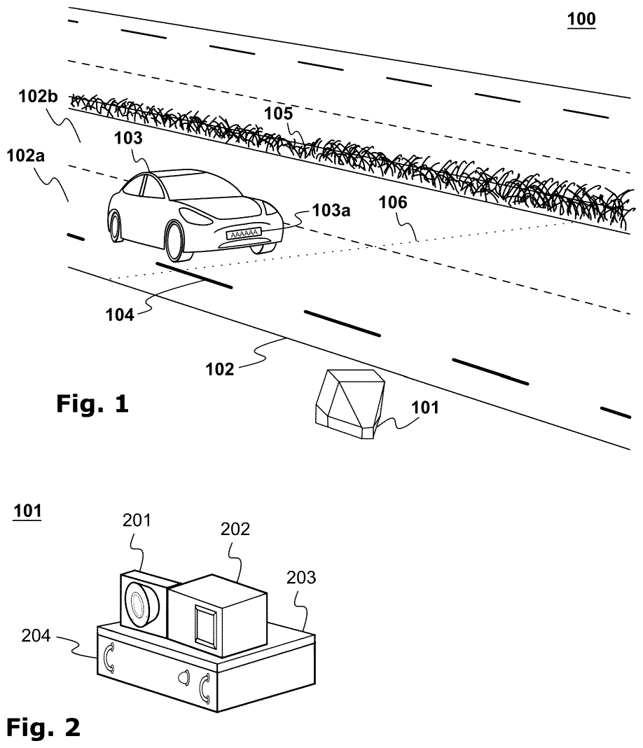

With reference to FIG. 1, by way of example of a road environment 100, a traffic enforcement device 101 is positioned in the vicinity of a road 102 along which a vehicle 103 equipped with a registration plate 103a is being driven. The road 102 may be any type of drivable space permitting passage of vehicles, for example: a motorway, a street, a path, etc. In the example of FIG. 1, the road 102 comprises two traffic lanes 102a, 102b, delineated by various markings 104 applied to the surface of the road 102 and/or separating elements 105 such as a median strip. The markings 104 generally take the form of markers consisting of visual signs such as a continuous line, a broken line, or even studs.

In general, the enforcement device 101 is oriented toward a line of enforcement 106 that acts as a reference line for speed checks. The line of enforcement 106 is generally a virtual line the position of which is defined during installation of the traffic enforcement device 101. In some use cases, it may correspond to a stop line associated with a set of traffic lights or to a yield line.

With reference to FIG. 2, the traffic enforcement device 101 comprises a camera 201 and a radar 202. The camera 201 and the radar 202 are configured so as to be able to be positioned at the edge of a road, so as to be able to acquire data relating to the path of vehicles being driven on a segment of the road. In this respect, the camera 201 and the radar 202 are fastened to a holder 203. The relative orientation and position of the camera with respect to the radar are considered to be known and fixed, at least during the periods of acquisition of data.

In embodiments, the traffic enforcement device 101 is mobile, i.e. the holder 203, the camera 201 and the radar 202 are movable from one location to another depending on how the traffic enforcement device 101 is required to be used. The holder 203 is generally configured to be placed on a tripod or fastened to a scaffold.

By “radar”, what is meant is any device exploiting electromagnetic waves that allows the presence of an object to be detected and its spatial position, and optionally its speed, to be determined. Examples of “radar” suitable for a traffic enforcement device are Doppler radar and LIDAR.

The position measurements of a radar 202 are generally insensitive to its height and angle of elevation. The data relating to the path of a vehicle 103 tracked by a radar 202 comprise the position of the vehicle along a radial axis defined between said vehicle and the radar. The speed of the vehicle 103 may be computed on the basis of the angle of azimuth between the radial axis and the velocity vector of said vehicle 103.

In embodiments, the traffic enforcement device 101 further comprises a controller 204. The controller 204 comprises one or more processors for processing the data and signals necessary for the operation of the traffic enforcement device 101. It further comprises a non-transient data storage memory, for example of any type, for example a flash memory, EEPROM, HDD, SDD, etc. It may also be connected to a user interface (not shown) in order to facilitate configuration of the traffic enforcement device 101 by an operator. It may further be connected to a communication device (not shown) with a view to transmitting data collected during surveillance of the road 102 to a remote server. The controller 204 is generally configured to actuate the camera 201 and/or the radar 202, and optionally to process the data acquired by the camera 201 and the radar 202.

The controller 204 may also be configured to implement the method according to the invention. To this end, code instructions of a computer program may be stored in its non-transient storage memory, said instructions, when they are executed by one or more of its processors, implementing the method according to the invention.

According to some embodiments, instead of the controller 204, the method is implemented by a processing unit located remotely, for example on a remote server communicating with the controller 204 via a telecommunications network.

The method for calibrating the traffic enforcement device advantageously allows position parameters of the camera 201 in a reference frame associated with the lane 102a of the road 102, and in particular the parameters quantifying the height and elevation of the camera 201, to be finely calibrated. The method is implemented once the traffic enforcement device 101 has been positioned at the edge of a road 102 along which the vehicles 103 to be controlled are being driven. The traffic enforcement device 101 is positioned at the edge of the road 102 in such a way that the camera 201 and the radar 202 are oriented toward the lane 102a of the road 102 to be monitored, and thus are able to acquire data relating to the path of the vehicles 103. In the images acquired by the camera 201, a portion of the lane 102a of the road 102 level with the line of enforcement 106 is visible.

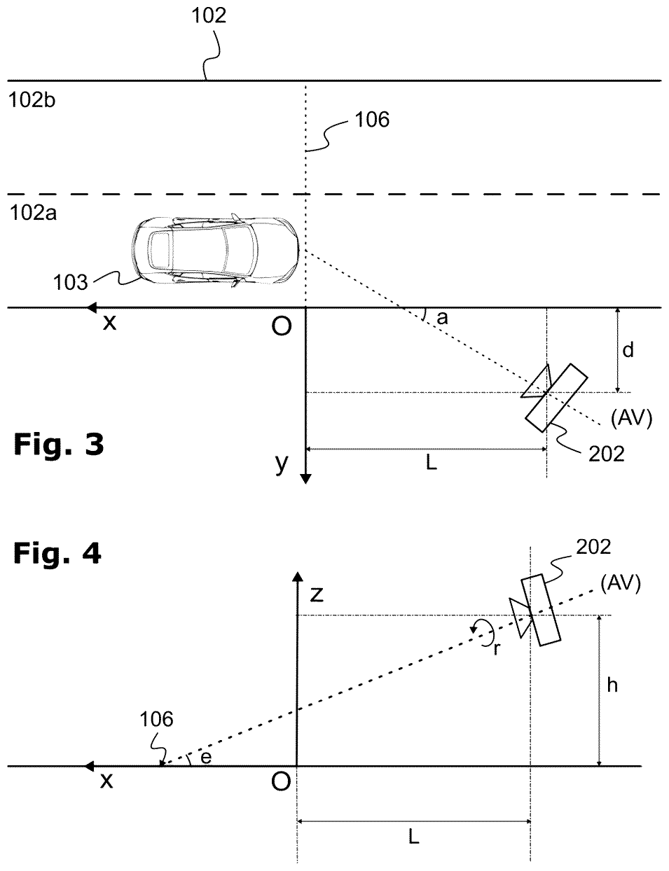

With reference to FIGS. 3 & 4, the position and orientation of the camera 201 are represented by position and orientation parameters in a reference frame (O, x, y, z) associated with the lane 102a of the road 102, respectively. For the sake of simplicity, the radar 202 has not been shown.

The reference frame (O, x, y, z) associated with the lane 102a of the road 102 is a direct orthonormal reference frame such that:
the axis [Ox) is tangential to one of the two edges of the road 102 and is contained in the plane of the lane 102a of the road 102,
the axis [Oy) is contained in the plane of the road 102,
the axis [Oz) is orthogonal to the plane of the road 102.

The origin O of the reference frame is such that the camera 201 has a position on the ground with coordinates (−L, d, h), where (−L, d and h) are position parameters of the camera 201 such that:
L is a predefined constant, generally corresponding to the distance to the line of enforcement 106—this distance is set arbitrarily, and for example equal to 28 m;
d is the road-edge distance, i.e. the distance between the camera 201 and the edge of the road 102, in particular the edge of the road closest to the camera 201 along the axis [Oy)—this distance may initially be estimated;
h is the height of the camera 201 with respect to the road 102—this height may initially be estimated by an operator.

The orientation parameters of the camera 201 in the reference frame (O, x, y, z) associated with the road 102 are:
the azimuth, a, corresponding to the angle between the line of sight (AV) of the camera 201 and the axis [Ox) tangential to the road 102;
the roll, r, corresponding to an angle of the camera 201 about its line of sight (AV); and
the elevation, e, corresponding to the angle between the line of sight (AV) of the camera 201 and the plane of the lane 102a of the road 102.

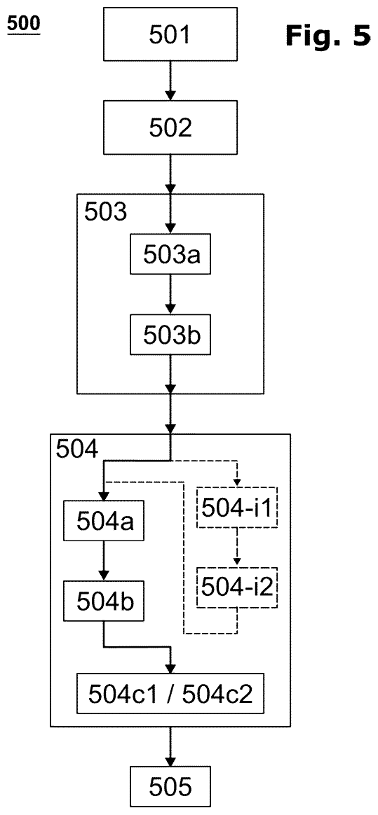

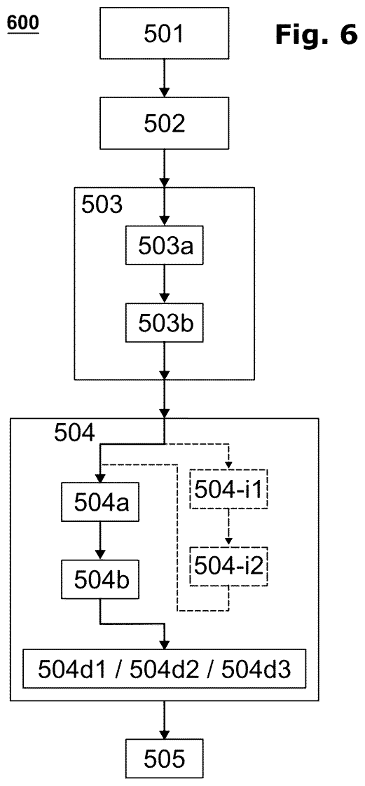

With reference to FIG. 5, the method 500 comprises a first step 501 of estimating position and orientation parameters of the camera 201 and of the radar 202 in the reference frame (O, x, y, z) associated with the road 102, so as to obtain an initial value for each of said parameters. In particular, the value of the parameter L being set, an initial estimation of the angle of elevation e, of the angle of azimuth a, of the angle of roll r, of the road-edge distance, d, and of the height h is made.

Advantageously, the step 501 of estimating position and orientation parameters of the camera 201 may be implemented using a method such as the one described in FR 3131777 A1 [IDEMIA IDENTITY & SECURITY FRANCE [FR]] 14.07.2023. In this method, the estimation of the parameters is based, on the one hand, on a rectilinear road model and, on the other hand, on two parametric curves, B-splines for example, representing the edges of said road as visible in the image acquired by the camera. The parameters are determined so that the rectilinear road model corresponds to the road shown in the image and the edges of which are modeled by the parametric curves.

In embodiments, the road-edge distance, d, and the height, h, are estimated by the operator, and the method described in FR 3131777 A1 [IDEMIA IDENTITY & SECURITY FRANCE [FR]] 14.07.2023 is solely used to estimate values of the orientation parameters (a, e, r). Alternatively, the road-edge distance, d, and the height, h, may be the subject of an initial estimation by the operator, then the method described in FR 3131777 A1 [IDEMIA IDENTITY & SECURITY FRANCE [FR]] 14.07.2023 may be used to refine this initial estimation and to estimate the orientation parameters (a, e, r).

Furthermore, the relative position and orientation of the radar 202 with respect to the camera 201 are considered known (determined during mounting in the factory). The position parameters of the radar 202 in the reference frame (O, x, y, z) of the lane 102a of the road 102 may be determined on the basis of those of the camera 201.

The method then comprises a step 502 of acquiring, by means of the camera 201 and of the radar 202, data relating to the path of at least one given vehicle 103 on the lane 102a of the road 102. Generally, the higher the number of vehicles the path of which is tracked, the more accurate and stable the calibration will be. Preferably, in practice, the path data are acquired for at least two or more vehicles, for example between two and ten vehicles.

The data acquired by the camera 201 in step 502 may comprise a succession of images showing the vehicle 103 being driven in the lane 102a of the road 102. These data may be acquired at the sampling frequency of the camera 201.

In the acquiring step 502, the data acquired by the radar 202, for example in the case of a Doppler radar, may comprise a series of radial velocities of the vehicle 103 with respect to the line of sight (AV) of the radar 202.

The data acquired by the camera 201 and the radar 202 are time-stamped.

The method comprises a step 503 of determining the paths of the or each vehicle 103 in the reference frame (O, x, y, z) associated with the road 102, on the basis of the data acquired on the one hand by the camera 201 and on the other hand by the radar 202. This step 503 comprises, for each vehicle, two substeps:
a substep 503a of determining a first path, called the “camera path”, of the vehicle 103 in the reference frame (O, x, y, z) associated with the road 102 on the basis of the data acquired by the camera 201 and of the position and orientation parameters of the camera 201 estimated in the estimating step 501;
a substep 503b of determining a second path, called the “radar path”, of a given vehicle 103, in the reference frame (O, x, y, z) associated with the road 102, on the basis of the data acquired by the radar 202 and of its known position and orientation parameters, for example, in the case of Doppler radar, its angle of azimuth and its positions along the axes [Ox) and [Oy) in the reference frame (O, x, y, z) associated with the road 102.

The radar path and the camera path each comprise data on the position of the vehicle 103 in the reference frame (O, x, y, z) associated with the road 102, and more precisely time sequences of position data in this reference frame.

These position data are determined, in a manner known to those skilled in the art, on the basis of the data acquired by the camera 201 and by the radar 202 using operations for changing reference frame. These operations for changing reference frame are carried out based on the position and orientation parameters estimated in step 501 and on intrinsic parameters specific to the model of the camera 201 and of the radar 202. By way of example, for the camera 201, the change of reference frame comprises a succession of changes of reference frame from the position of the vehicle 103 in the image acquired by the camera 102 to the reference frame (O, x, y, z) associated with the road 102.

The method then comprises a step 504 of computing, on the basis of the camera path and of the radar path, corrected values for at least some of the estimated position and orientation parameters of the camera 201, including at least corrected values for the angle of elevation, e, and for the height, h, of said camera 201.

In embodiments, the computing step 504 comprises solely a computation of corrected values for the angle of elevation, e, and for the height, h, of the camera 201. As a variant, it comprises a substep 504a of computing corrected values for the angle of elevation, e, and for the height, h, and a substep 504b of correcting other position and orientation parameters of the camera 201, which may include the road-edge distance, d, and/or the angle of roll, r, on the basis of the corrected values for the angle of elevation, e, and for the height, h. The distance L to the line of enforcement 106, which is set arbitrarily, is not recomputed. The angle of azimuth, a, since it is the position parameter on the basis of which the radar path that serves as a reference for the camera path is derived, is not recomputed either.

As indicated above, the radar path and the camera path each comprise one or more time sequences of data on the position of the vehicle 103 in the reference frame (O, x, y, z) associated with the road 102. In embodiments, the step 504 of computing corrected values for the position and orientation parameters is implemented on the basis of a comparison between the data on the position of the vehicle 103 obtained by the radar 202 and the position data obtained by the camera 201. These position data correspond to identical acquisition times. By “comparison”, what is meant is any suitable operation allowing a difference between two data to be determined.

In some cases, in particular when the camera 201 and the radar 202 have different acquisition rates, the radar path and the camera path may comprise data on the position of the vehicle 103 corresponding to different acquisition times. The computing step 504 may then comprise a preliminary correcting substep 504-i1 so that the two paths comprise data on the position of the vehicle corresponding to identical acquisition times, and thus become comparable. The correcting substep 504i-1 may in particular comprise an interpolation of either of the radar and camera paths. In general, interpolation is performed for the path with the lowest acquisition rate. By “correction”, what is meant is any suitable operation for reducing or removing a discrepancy between two data.

In embodiments, the step 504 may further comprise a preliminary substep 504-i2 of limiting the time sequence of data acquired by the radar 202 so that it corresponds to an interval of given positions along the axis [Ox). It may also comprise limiting the time sequence of data acquired by the camera 201 so that it corresponds to the same time sequence as that of the radar 202. Thus, the data processed in the remainder of the method are reduced down to only data that is actually relevant.

In a first embodiment, the data on the position of the vehicle 103 in the reference frame (O, x, y, z) associated with the road 102 comprise a time series of positions of said vehicle 103 along the axis [Ox) of the reference frame (O, x, y, z) associated with the road 102. The step 504 of computing corrected values for the angle of elevation, e, and for the height, h, of the camera 201, then comprises a substep 504c1 of minimizing differences between the time series of the camera path and the time series of the radar path.

In embodiments, a metric of the distance between the positions of the vehicle 103 along the axis [Ox) obtained on the one hand by the camera 201 and on the other hand by the radar 202 is determined. The step 504 of computing corrected values for the angle of elevation, e, and for the height, h, of the camera 201 then comprises a substep 504c2 of minimizing this distance over the entire time series or, in the case of a plurality of vehicles, in all of the time series.

The metric used may for example be the quadratic sum of the Euclidean distances between the coordinates along the axis [Ox) at each acquisition time t, for the camera 201 and the radar 202, respectively. As a variant, other distances may be considered, such as the Manhattan distance (or distance L1), or the Mahalanobis distance.

The values of the angle of elevation, e, and of the height, h, minimizing the determined metric may for example be determined using a function that seeks an overall minimum in a function with a plurality of variables (in the present case two variables corresponding to the angle of elevation and height), or via nested iterative loops in which the height and elevation are successively varied by a set increment. The increment may for example be between 0.005° and 0.05° for the angle of elevation, and preferably between 0.005° and 0.02°, and between 0.005 m and 0.05 m for the height, and preferably between 0.005 m and 0.02 m.

Advantageously, the method comprises a step 505 of updating the angle of roll, r, and the road-edge distance, d, once the values of the height, h, and of the angle of elevation, e, have been corrected using the corrected values computed in step 504. This update is carried out by reiterating the method described in FR 3131777 A1 [IDEMIA IDENTITY & SECURITY FRANCE [FR]] 14.07.2023, with all the parameters other than the angle of roll, r, and the road-edge distance, d, set.

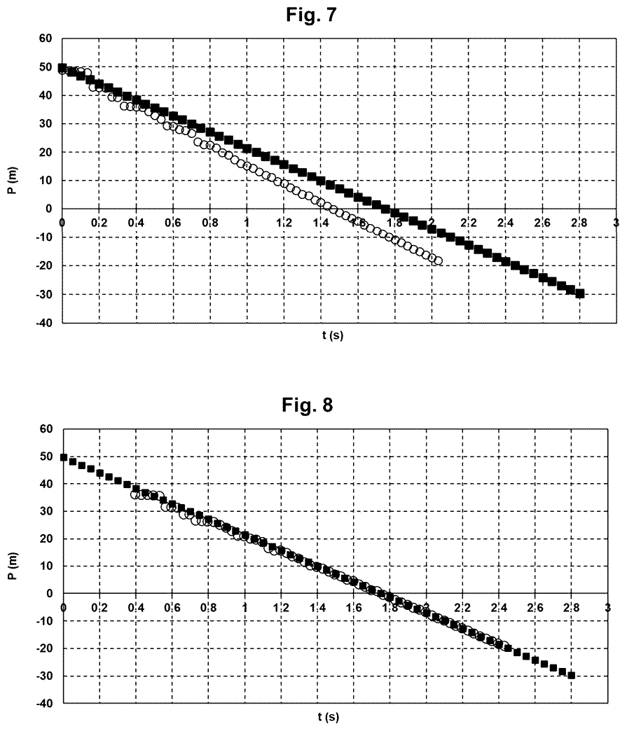

In FIG. 7, the position (expressed in meters), as a function of time (expressed in seconds), of a given vehicle 103 according to the camera 201 (empty circles) and according to the radar 202 (black squares) of the traffic enforcement device 101 have been shown, each path being formed by a time series of positions of the vehicle 103 along an axis [Ox) tangential to an edge of the road 102. The two paths do not coincide.

In FIG. 8, the paths of FIG. 7 after correction of the position and orientation parameters of the camera 201 with corrected values computed using the method according to the invention have been shown. In this example, the following corrective values were computed:
angle of elevation e: +0.11°
height h: −0.1 m
road-edge distance d: −0.3 m
angle of roll r: −0.2°

The corrections were of the order of one tenth or even one hundredth of a degree for the angles, and of one tenth of a meter for the distances. The offset along the [Ox) axis between the two radar and camera paths was substantially reduced.

In a second embodiment, the position data comprise a time series of distances of the vehicle 103 from the traffic enforcement device 101. By “distance of the vehicle from the traffic enforcement device”, what is meant is the distance of the vehicle from the camera 201 or radar 202 of the traffic enforcement device 101, the camera 201 and the radar 202 being assumed to be sufficiently close to each other for these two distances to be considered to be substantially equal.

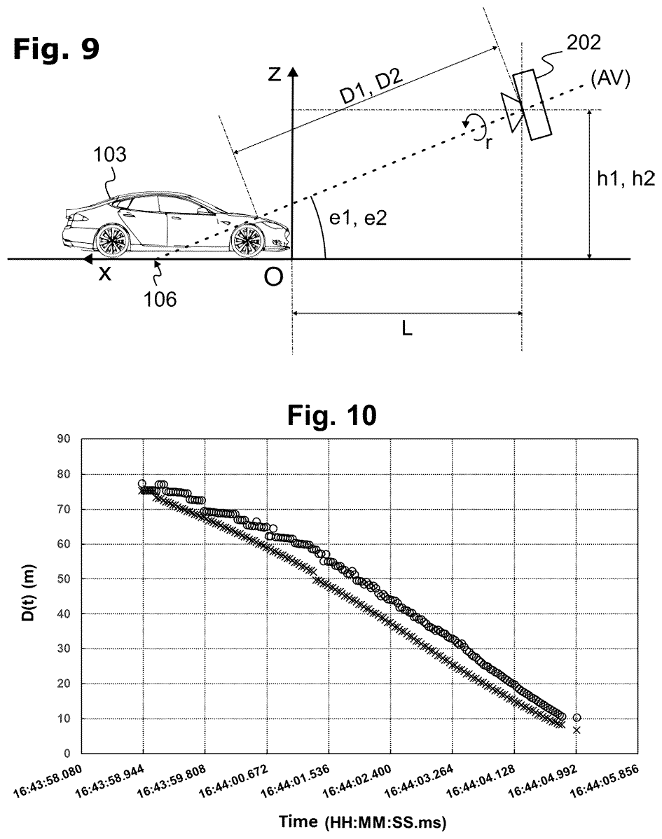

FIG. 9 schematically shows the distance of a vehicle 103 from the traffic enforcement device 101, as opposed to its position along the axis [Ox). The following notations are used:

D1 is the distance of the vehicle 103 from the traffic enforcement device 101 obtained by the radar 202. This distance is deemed accurate since its accuracy is independent of the height and angle of elevation of the radar. A time sequence of values D1(t) for each vehicle is acquired in the acquiring step 501.

D2 is the distance of the vehicle 103 from the traffic enforcement device 101 as obtained by the camera 201. Before calibration, the distance D2 is generally different from the distance D1. A time sequence D2(t) is acquired for each vehicle in the acquiring step 501 (where appropriate with interpolation of the values of the sequence).
h1 is the exact height of the camera 201, its value being unknown.
h2=h1+Δh is the estimated height of the camera 201, its value being known in the step 501 of estimating position and orientation parameters. The parameter Δh is the corrective height parameter expressing the difference between h1 and h2, its value being unknown.
e1 is the exact elevation of the camera, its value being unknown.
e2=e1+Δe is the estimated elevation of the camera 201, its value being known in the step 501 of estimating position and orientation parameters. The parameter Δe is the corrective elevation parameter expressing the difference between e1 and e2, its value being unknown.

The spatial arrangement of the traffic enforcement device 101 with respect to the road 102 means that the height h1 and the distance D1 are large and the angle of elevation, e, relatively small. Thus, the approximation sin (e1)=e1 and sin (e2)=e2 is reasonable, and consequently e1=h1/D1 and e2=h2/D2.

This approximation allows the following relationship to be deduced:

$$D 2 = \frac{h 2}{e 1 + Δ e} = \frac{h 2}{( \frac{h 1}{D 1} ) + Δ e}$$

Applied to the time sequences D1(t) and D2(t), the preceding relationship takes the following form:

$$D 1 ( t ) * \frac{h 2}{D 2 ( t )} = h 1 + Δ e * D 1 ( t )$$

Thus, according to the second embodiment, the step 504 of computing corrected values comprises a substep 504d-1 of computing the ratio D1(t)*h2/D2(t) as a function of D1(t), and a substep 504d-2 of modeling this ratio with an affine function dependent on D1(t). The slope of the affine function corresponds to the corrective elevation parameter Δe, and the y-coordinate at the origin corresponds to the parameter h1, i.e. to the exact value of the height of the camera 102. In a substep 504d-3, the corrected values, h1 and e1, for the height h and for the angle of elevation e, respectively, are computed.

As in the first embodiment, the method 500 may comprise a step 505 of updating the angle of roll, r, and the road-edge distance, d, once the values of the height, h, and of the angle of elevation, e, have been corrected using the corrected values computed in step 504. This update is carried out by reiterating the method described in FR 3131777 A1 [IDEMIA IDENTITY & SECURITY FRANCE [FR]] 14.07.2023, with all the parameters other than the angle of roll, r, and the road-edge distance, d, set.

In FIG. 10, the distances D1(t) (crosses) and D2(t) (empty circles), as a function of time, of a given vehicle 103, from the camera 201 and the radar 202 (in the present case a Doppler radar) of the traffic enforcement device 101 have been shown, each path being formed by a time series of distances. This graph shows that before calibration the two paths do not coincide.

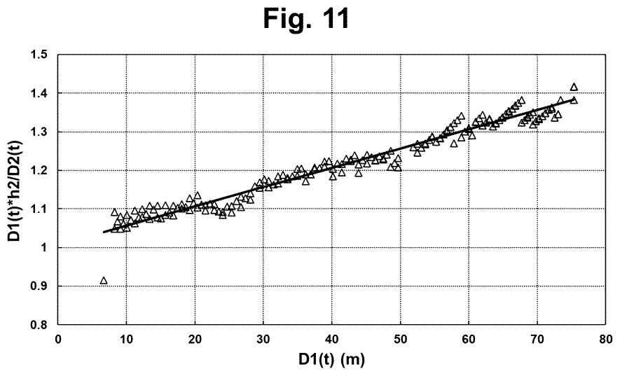

FIG. 11 shows the variations in the ratio D1(t)*h2/D2(t) as a function of D1(t) (empty triangles), computed for each acquisition time, and modeling thereof by an affine function (solid line). The obtained value of the corrective elevation parameter, corresponding to the slope of the affine function, is 0.005 radians or 0.29°, and the value of the height h1 of the camera 201, corresponding to the y-coordinate at the origin of the affine function, is 1.01 m.

By virtue of the method of the invention, the position and orientation parameters of the camera 201 are determined with increased accuracy. The traffic enforcement device 101 may then carry out speed checks accurately using its camera 201, thus meeting the requirements of the legislative and/or administrative regulations currently in force.

1. A method for calibrating a traffic enforcement device comprising a camera and a radar, the method comprising:
estimating position and orientation parameters of the camera and the radar in a reference frame associated with a lane of a road;
acquiring, by means of the camera and radar, data relating to the path of at least one given vehicle in the lane of the road;
determining a camera path of the vehicle in the reference frame associated with the lane of the road based on the data acquired by the camera and of the estimated position and orientation parameters, and determining a radar path of the vehicle in the reference frame associated with the lane of the road based on the data acquired by the radar and of the estimated position and orientation parameters; and
computing, based on the camera path and of the radar path, corrected values for at least some of the estimated position and orientation parameters of the camera, including a parameter quantifying the angle of elevation, e, and a parameter quantifying the height, of said camera.

2. The method as claimed in claim 1, wherein the radar path and the camera path each comprise data on the position of the vehicle in the reference frame associated with the lane of the road, said data being acquired at respective acquisition times, and the step of computing corrected values for the parameters comprises a substep of correcting the data on the position of the vehicle of the radar path and of the camera path for identical acquisition times.

3. The method as claimed in claim 2, wherein the radar and the camera have different data acquisition rates, and the correcting substep comprises an interpolation of one of the radar path and/or camera path so that both paths comprise position data corresponding to identical acquisition times.

4. The method as claimed in claim 1, wherein the computing step comprises computing corrected values for angle of elevation, and for height, and said method comprises a step of updating the value of at least one of a road-edge distance, and of an angle of roll, of the camera on the basis of said corrected values.

5. The method as claimed in claim 1, wherein the camera path and the radar path each comprise a time series of positions of the vehicle along an axis of the reference frame associated with the lane of the road, the axis being tangential to an edge of the lane of the road, and the step of computing corrected values comprises computing corrected values for the angle of elevation, and for the height, of the camera, and a substep of minimizing differences in position between the time series of the camera path and radar path.

6. The method as claimed in claim 1, wherein the camera path and the radar path each comprise a time series of distances of the vehicle from the traffic enforcement device, and the step of computing corrected values for the position and orientation parameters of the camera comprises a substep of minimizing the distance in all of said time series.

7. The method as claimed in claim 6, wherein the step of computing corrected values comprises:
computing a quantity D1(t)*H2/D2(t) as a function of D1(t), where D1(t) is the time sequence of distances of the vehicle from the traffic enforcement device provided by the radar, D2(t) is the time sequence of distances of the vehicle from the traffic enforcement device provided by the camera, and H2 is the estimated height of the camera;
modeling the quantity D1(t)*H2/D2(t) as a function of D1(t) with an affine function; and
computing a correction of the angle of elevation, using the value of the slope of the affine function, and the corrected value for the height, of the camera based on the y-coordinate at the origin of the affine function.

8. A non-transitory computer-readable medium storing a computer program, comprising instructions that, when executed by processing circuitry, cause the processing circuitry to implement a method comprising:
estimating position and orientation parameters of a camera and a radar in a reference frame associated with a lane of a road;
controlling the camera and the radar so as to acquire, by means of the camera and the radar, data relating to the path of at least one given vehicle in the lane of the road;
determining, a camera path of the vehicle in the reference frame associated with the lane of the road based on the data acquired by the camera and of the estimated position and orientation parameters, and determining a radar path of the vehicle in the reference frame associated with the lane of the road based on the data acquired by the radar and of the estimated position and orientation parameters; and
computing, based on the camera path and of the radar path, corrected values for at least some of the estimated position and orientation parameters of the camera, including a parameter quantifying the angle of elevation, and a parameter quantifying the height, of said camera.

9. A traffic enforcement device, comprising the camera, the radar, and the processing circuitry, the traffic enforcement device being configured to implement the calibrating method as claimed in claim 1.
